(19) United States
(12) Patent Application Publication
(10) Pub. No.: US 2011/0102330 A1
(43) Pub. Date: May 5, 2011

(54) Touch control click structure

(76) Inventor: Tony Chen, Shengang Shiang (TW)

(21) Appl. No.: 12/588,988

(22) Filed: Nov. 4, 2009

(51) Int. Cl. G06F 3/041

(52) U.S. Cl. 345/173

(57) ABSTRACT

A touch control click structure includes at least an action board swayable up and down, a click switch and a touch panel. The action board has an axle mechanism at one end that is fastened to a chassis in an integrated manner, an extension zone in a middle portion and a click zone at another end that is swayable. The click switch aims to control input movements and is located below the action board. The touch panel is located above the click zone. The extension zone is formed at a desired length such that any position of the click zone can get a depressing pressure approximate to each other when depressed. Therefore the click zone can be swayed steadily up and down. The touch panel also provides position detecting function such that different output signals are generated when different positions are depressed

### BACKGROUND OF THE INVENTION

1. Field of the Invention

The present invention relates to a touch control click structure and particularly to a touch control click structure that can provide an even clicking pressure to enhance clicking accuracy.

2. Description of the Prior Art

With advances of semiconductors the functions of electronic devices grow gradually. Integration of different products also is a growing trend, such as integration of handsets with music players, cameras and the like. Hence operation and control become more complicated. The conventional button keys can no longer meet such a challenge. As a result, touch screen click gradually becomes the mainstream of operation of electronic products. It makes functional changes easier, contrasted with the conventional button keys that require more keys as the function increases.

However, the touch control click also has drawbacks. For instance, it does not produce a crisp click like the conventional key to enable users to get a clear sense whether the key stroke is effective. Moreover, the touch control click is more sensitive and responsive at a slight touch. Hence erroneous hits take place more frequently. The keys on the touch control screen also are positioned closer relative to each other, as a result faulty clicks occur more likely.

### SUMMARY OF THE INVENTION

The touch control click is designed with one key to replace multiple keys. To achieve this end a touch panel is divided into a plurality of segments. When depressed the entire key is swayed up and down. Depending on different depressing positions of the finger signals representing different meanings are output. As the clicking area is quite large, how to produce the click at each spot with about the same click sense is important. Making the key to sway up and down steadily also is an important issue. One of the conventional approaches is to position a horizontal axle at one end of the key. This makes the key swayable up and down. But a greater depressing force is needed at one end closer to the axle while a less depressing force is needed at other end remote from the axle due to a longer depressing distance. In view of such a phenomenon the Applicant develops a technique that enables the depressing force and depressing distance of each click spot close to one another. And an extension zone is provided between a click zone and the axle to make the entire click zone spaced from the axle at a longer distance. As a result the entire click zone can get a more even depressing pressure and distance to overcome the aforesaid problems.

Therefore it is an object of the present invention to provide a touch control click structure that can provide an even clicking pressure to enhance clicking accuracy. It includes at least an action board swayable up and down, a click switch and a touch panel. The action board has an axle mechanism at one end that is fastened to a chassis in an integrated manner, an extension zone in a middle portion, and a click zone at another end that is swayable. The click switch aims to control input movements, and is located below the action board. The touch panel is located above the click zone. By increasing the length of the extension zone any position of the click zone can get a depressing pressure approximate to each other. Therefore the click zone can be swayed up and down steadily. The touch panel also provides position detecting function such that different output signals are generated when different positions are depressed.

In one aspect the extension zone is formed at a length greater than 0.5 times of the length of the click zone.

In another aspect the extension zone has a carved housing space in the middle to hold other elements such as a display device or circuits or the like.

In yet another aspect the extension zone is made of metal to enhance the rigidity.

In yet another aspect the extension zone is concealed in the interior of the chassis, and the click zone is exposed outside the chassis.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of an embodiment of the invention.

FIG. 2 is a plane view of an embodiment of the invention.

FIG. 3 is a schematic view of a second embodiment of the invention.

FIG. 4 is a schematic view of a third embodiment of the invention.

FIG. 5 is a schematic view of a fourth embodiment of the invention.

### DESCRIPTION OF THE PREFERRED EMBODIMENTS

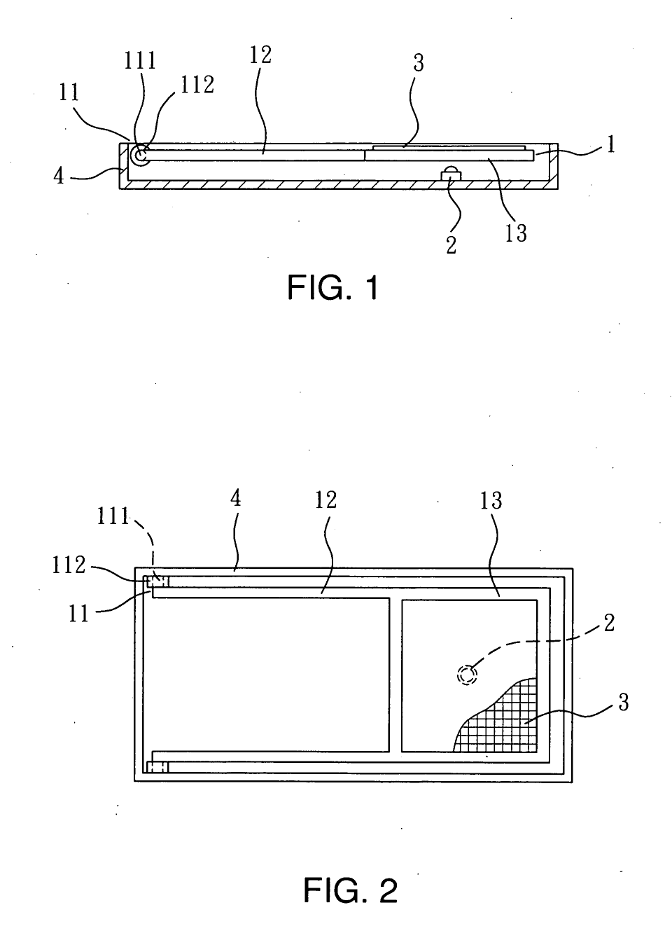

Referring to FIGS. 1 and 2, the touch control click structure according to the invention includes at least an action board 1 swayable up and down, a click switch 2 and a touch panel 3. The action board 1 has one end with an axle mechanism 11 located thereon to be fastened to a chassis 4, an extension zone 12 at a middle portion, and another end swayable to become a click zone 13. The click switch 2 is located below the action board to control input movements. The touch panel 3 is located above the click zone 13. The extension zone 12 is formed at a desired length such that when any position of the click zone 13 is depressed an approximate same depressing pressure is formed so that the click zone 13 can be swayed steadily up and down. The touch panel 3 has position detecting capability. When different positions are depressed different output signals are generated.

In one aspect the touch panel 3 is a touch control display device.

In another aspect the extension zone 12 is made of metal to enhance the rigidity. It is formed at a length greater than 0.5 times of the click zone 13.

In yet another aspect the axle mechanism 11 includes an axle 111 and a corresponding axle sleeve 112 so that when the click zone 13 is depressed by a user's finger the action board 1 can be swayed up and down about the axle.

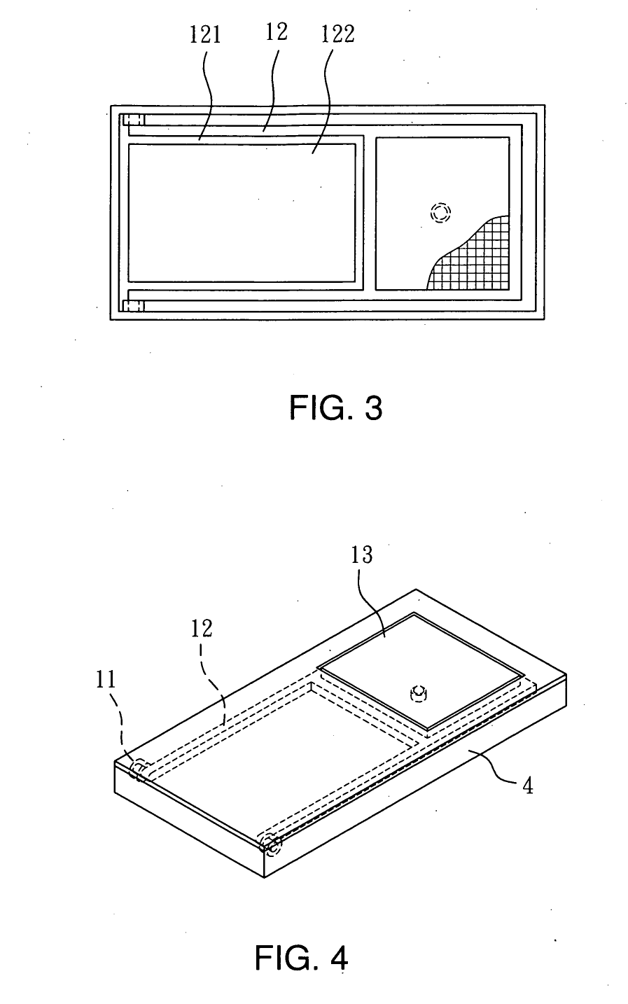

Refer to FIG. 3 for a second embodiment of the invention. To meet the prevailing trend of slim and light for electronic products the extension zone 12 has a carved housing space 121 in the middle to hold other elements 122 such as a display device or circuit elements or the like.

Refer to FIG. 4 for a third embodiment of the invention. The invention can be integrated with (or replace) the input devices of the existing equipments. The extension zone 12 and axle mechanism 11 can be concealed in the interior of the chassis 4, and the click zone 13 is exposed outside the chassis 4 to enhance aesthetic appeal and safety.

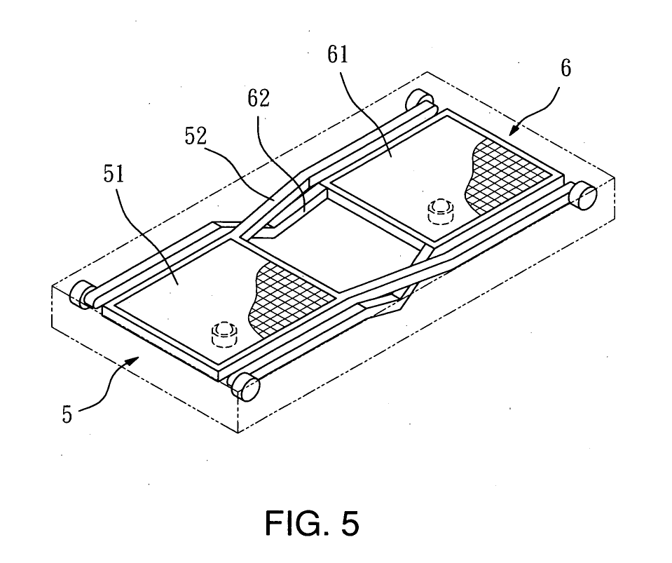

Refer to FIG. 5 for a fourth embodiment of the invention. In a condition in which shrinking the size to provide more click zones 51 and 61 is desired, the invention may include two touch control click structures 5 and 6 installed in a cross manner. The structure is substantially same as the previous embodiments. The only difference is that two extension zones 52 and 62 are bent at the cross location to prevent them from jamming each other.

I claim:

1. A touch control click structure, comprising at least an action board swayable up and down, a click switch and a touch panel, wherein:
the action board has one end which has an axle mechanism located thereon fastened to a chassis, an extension zone located at a middle portion and a swayable click zone located at another end;
the click switch is located below the action board to control input movement; and
the touch panel is located above the click zone;
wherein the extension zone is formed at a desired length such that any position of the click zone is depressible to form an approximate pressure to allow the click zone to sway steadily up and down, the touch panel being equipped with position detecting function so that different signals are generated when different positions are depressed.

2. The touch control click structure of claim 1, wherein the length of extension zone is greater than 0.5 times of the click zone.

3. The touch control click structure of claim 1, wherein the extension zone is carved at a middle section to form a housing space to hold circuit elements.

4. The touch control click structure of claim 3, wherein the housing space holds a display device.

5. The touch control click structure of claim 1, wherein the extension zone is made of metal.

6. The touch control click structure of claim 1, wherein the extension zone is concealed in the interior of the chassis.

7. The touch control click structure of claim 1, wherein the touch panel is a touch control display device.

8. The touch control click structure of claim 1 further including two sets of the touch control click structure that are installed in a cross manner to increase the click zone, the extension zone being bent at the cross location to prevent jamming of each other.
